(19) United States
(12) Patent Application Publication
(10) Pub. No.: US 2004/0263873 A1
(43) Pub. Date: Dec. 30, 2004

(54) Image forming device and image forming method

(75) Inventors: Junji Sato, Tokyo (JP); Akio Ueda, Tokyo (JP); Masaru Ushio, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Business Technologies, Inc., Tokyo (JP)

(21) Appl. No.: 10/777,541

(22) Filed: Feb. 11, 2004

(30) Foreign Application Priority Data
Jun. 30, 2003 (JP) 2003-188226

(51) Int. Cl. G06F 15/00; H04N 1/46

(52) U.S. Cl. 358/1.6; 358/1.1; 358/501

(57) ABSTRACT

An image forming device includes: a control unit for accepting reservations of a plurality of jobs including an image forming processing, and for carrying out a job successive execution starting a next job during an image forming of a last page of a current job, based on the plurality of reserved jobs; and a conveyance path for conveying a transfer paper, from a start of a feed to an end of an exit; an image forming unit for forming and outputting an image on the transfer paper, based on an instruction from the control unit, wherein in case the maximum number of the conveyed transfer paper existing at the same time on the conveyance path is defined as N1, and the number of reservation acceptable jobs is defined as N2, the control unit sets the N2 as N2≧1, and manages acceptance of the jobs according to the N2.

### BACKGROUND OF THE INVENTION

1. Field of the Invention

The present invention relates to an image forming device and an image forming method such as a copier, a printer, a fax and a complex machine of such machines.

2. Description of Related Art

An image forming device of which the method of management for a job is contrived in order to improve productivity, when a plurality of reserved jobs are carried out sequentially, has been thought out so far. The job denotes a series of operations related to the image forming such as print out or the like. For example, when a plurality of sheets of originals are copied, a series of operations related to the copying of the plurality of sheets of originals is one job. When a plurality of copies of originals are copied, a series of operations related to the copying of the plurality of copies of the originals is one job.

For example, in the Japanese Patent Application Publication (Unexamined) Tokukai-2002-116674, an art for carrying out the image forming on transfer paper continuously without stopping an image forming process in the case that a next job is reserved when a last page of the transfer paper of a current job is fed, is disclosed.

However, when a large amount of outputs of small jobs (the job of which the number of outputs is small, on the order of one) are carried out, because of the relation between the number N2 of the jobs which can be accepted reservation (called the number of the reservation acceptable jobs) and the maximum number N1 of the transfer paper existing at the same time on a conveyance path from the start of the feed of the transfer paper to the end of the exit of the transfer paper in the device (called the maximum number of the conveyed transfer paper, or the maximum number of the transfer paper), sometimes the outputs are not carried out continuously, and the machine is once stopped. Therefore, it is pointed out that the total productivity is decreased.

In addition, even if the number of the reservation acceptable jobs are simply increased, there is problem that the burden of the control to the display system is increased. And further, there is problem that the appearance of the display system is complicated and difficult to understand.

### SUMMARY OF THE INVENTION

An object of the present invention is, to improve productivity when a large amount of outputs of small jobs are carried out, while a load on a display system is reduced.

To solve the above problem, according to the first aspect of the present invention,

an image forming device comprises:

a control unit for accepting reservations of a plurality of jobs including an image forming processing, and for carrying out a job successive execution which starts a next job during an image forming of a last page of a current job, based on the plurality of jobs of which the reservations are accepted; and

a conveyance path for conveying a transfer paper, from a start of a feed of the transfer paper to an end of an exit of the transfer paper;

an image forming unit for forming and outputting an image on the transfer paper, based on an instruction from the control unit,

wherein in a case that the maximum number of the conveyed transfer paper existing at the same time on the conveyance path of the transfer paper from the start of the feed to the end of the exit in the image forming device is defined as N1, and the number of reservation acceptable jobs is defined as N2, the control unit sets the number N2 as N2≧1, and manages acceptance of the jobs according to the set number N2 of the reservation acceptable jobs.

According to the first aspect of the present invention, the number N2 of the reservation acceptable jobs is set as N2≧N1, with respect to the maximum number N1 of the transfer paper existing on the conveyance path of the transfer paper from the start of the feed to the end of the exit in the image forming device. Then, the management of the jobs is carried out according to the set number N2 of the reservation acceptable jobs. Therefore, it is resolved that even if there is a job to be reserved, the reservation can not be accepted because of the limitation of the number N2 of the reservation acceptable jobs. Accordingly, it is resolved that the reservation-accepted job which is waiting for the feed is lost at the feed operation. Further, it is resolved that, because the continuous feed cannot be carried out, the machine is once stopped. Therefore, the job can be carried out effectively. Especially, on the occasion of a large amount of outputs of the small jobs, of which the number of outputs in one job is small, the productivity can be improved.

It is preferred that the image forming device further comprises:

an image reading unit,

wherein the image forming unit forms the image based on an image data read by the image reading unit.

According to the present invention, in a device for copying an image or the like which comprise an image reading unit, on the occasion of a large amount of outputs of small jobs of which the number of outputs in one job is small, the productivity can be improved.

It is preferable that the control unit is capable of accepting a reservation of a new job by exiting the last page of the job.

According to the present invention, the accepting of the reservation of the new job can be carried out by exiting the last page of each job. Accordingly, the flexibility of the accepting of the reservation is increased. Then, the successive processing can be carried out without increasing the number of the reservation acceptable jobs greatly.

It is preferred that the control unit receives the maximum number N1 of the conveyed transfer paper existing at the same time on the conveyance path of the transfer paper from the start of the feed to the end of the exit in the image forming device, based on a main body identification signal.

According to the present invention, the maximum number N1 of the conveyed transfer paper existing at the same time on the conveyance path of the transfer paper from the start of the feed to the end of the exit, is received based on the main body identification signal. Therefore, the appropriate setting of the N1 is available in each device.

It is preferred that the control unit sets the number N2 of the reservation acceptable jobs, based on the N1 received based on the main body identification signal.

According to the present invention, the number N2 of the reservation acceptable jobs is set based on the N1 received based on the main body identification signal. Therefore, the appropriate number N2 of the reservation acceptable jobs is set, according to a main body device.

It is preferred that the image forming device further comprises:

a display unit for displaying various information,

wherein the control unit carries out a display on the display unit according to the set number N2 of the reservation acceptable jobs.

According to the present invention, the display on the display unit is carried out according to the set number N2 of the reservation acceptable jobs. Therefore, the N2 can be identified easily in the display unit.

It is preferred that the display unit displays a tag or a job display area, which correspond to the decided number N2 of the reservation acceptable jobs.

According to the present invention, the tag or the job display area, which correspond to the decided number N2 of the reservation acceptable jobs, are displayed. Therefore, a user can identify the number of the reservation acceptable jobs with the display more easily.

It is preferred that the image forming device further comprises:

a display unit for displaying various information,

wherein the control unit controls the display unit to display the job display area, the number of the job display areas corresponding to the number N2 of the reservation acceptable jobs; and the control unit controls the display unit to assign information about the job, of which the reservation is accepted, to each job display area in one to one relation.

According to the present invention, the display unit is controlled in order to display the job display area, the number of the job display areas corresponding to the number N2 of the reservation acceptable jobs. And further, the display unit is controlled in order to assign the information about the job, of which the reservation is accepted, to each job display area in one to one relation. Therefore, the display according to the number N2 of the reservation acceptable jobs can be carried out on the display unit.

It is preferred that the image forming device is connectable with a finisher, and

wherein the control device sets the number N2 of the reservation acceptable jobs as N2≧N1, with respect to the maximum number N1 of the conveyed transfer paper exiting at the same time according to the conveyance path which is variable according to a model of the finisher and presence or absence of connection of the finisher.

According to the present invention, the number N2 of the reservation acceptable jobs can be set according to the conveyance path which is variable according to the model of the finisher and the presence or absence of the connection of the finisher.

According to the second aspect of the present invention,

an image forming method comprises:

accepting reservations of a plurality of jobs including an image forming processing;

carrying out a job successive execution which starts a next job during an image forming of a last page of a current job, based on the plurality of jobs of which the reservations are accepted; and

forming and outputting an image on a transfer paper, by using a conveyance path for conveying the transfer paper, from a start of the feed of the transfer paper to an end of an exit of the transfer paper;

wherein in a case that the maximum number of the conveyed transfer paper existing at the same time on the conveyance path of the transfer paper from the start of the feed to the end of the exit in an image forming device is defined as N1, and the number of the reservation acceptable jobs is defined as N2, in the accepting, a reservation which satisfies a condition of N2≧1 is acceptable.

According to the second aspect of the present invention, the number N2 of the reservation acceptable jobs is set as N2≧N1, with respect to the maximum number N1 of the conveyed transfer paper existing on the conveyance path of the transfer paper from the start of the feed to the end of the exit in the image forming device. Then, the jobs are controlled according to the set number N2 of the reservation acceptable jobs. Therefore, it is resolved that even if there is a job to be reserved, the reservation can not be received because of the limitation of the number N2 of the reservation acceptable jobs. Accordingly, it is resolved that the reservation-accepted job which is waiting for the feed is lost at the feed operation. Further, it is resolved that, because the continuous feed cannot be carried out, the machine is stopped. Therefore, the job can be carried out effectively. Especially, on the occasion of a large amount of outputs of the small jobs, of which the number of outputs in one job is small, the productivity can be improved.

It is preferred that the image forming method further comprises:

receiving an image data by reading the image,

wherein the forming and the outputting is carried out based on the received image data.

According to the present invention, in a device for copying an image or the like which comprise an image reading unit, on the occasion of a large amount of outputs of small jobs of which the number of outputs in one job is small, the productivity can be improved.

It is preferred that the image forming method, wherein the accepting is capable of accepting a reservation of a new job by exiting the last page of the job.

According to the present invention, the accepting of the reservation of the new job can be carried out by exiting the last page of each job. Accordingly, the flexibility of the accepting of the reservation is increased. Further, the successive processing can be carried out without increasing the number of the reservation acceptable jobs greatly.

It is preferred that in the accepting, the maximum number N1 of the conveyed transfer paper existing at the same time on the conveyance path of the transfer paper from the start of the feed to the end of the exit is received, based on a main body identification signal.

According to the present invention, the maximum number N1 of the conveyed transfer paper existing at the same time on the conveyance path of the transfer paper from the start of the feed to the end of the exit is received, based on the main body identification signal. Accordingly, the setting of the appropriate N1 is can be carried out in each device, with no additional setting operation.

It is preferred that in the accepting, the number N2 of the reservation acceptable jobs is decided, based on the N1 received based on the main body identification signal.

According to the present invention, the number N2 of the reservation acceptable jobs is set based on the N1 received based on the main body identification signal. Accordingly, the appropriate number N2 of the reservation acceptable jobs is set, according to a main body device.

It is preferred that the image forming method further comprises:

displaying various information on a display unit,

wherein the displaying is carried out by displaying on the display unit according to the number N2 of the reservation acceptable jobs.

According to the present invention, the displaying on the display unit is carried out according to the number N2 of the reservation acceptable jobs. Accordingly, the identification of the N2 can be carried out easily in the display unit.

It is preferred that the displaying is carried out by displaying a tag or a job display area, which correspond to the number N2 of the reservation acceptable jobs.

According to the present invention, the tag or the job display area, which correspond to the number N2 of the reservation acceptable jobs, is displayed. Accordingly, a user can identify the number of the reservation acceptable jobs with the display more easily.

It is preferred that the image forming method further comprises:

the displaying various information on the display unit,

wherein the displaying is carried out by displaying the display area, the number of the display areas corresponding to the number N2 of the reservation acceptable jobs; and the displaying is carried out by assigning information about the job, of which the reservation is accepted, to each job display area in one to one relation.

According to the present invention, the display unit is controlled in order to display the job display area, the number of the display areas corresponding to the number N2 of the reservation acceptable jobs. In addition, the display unit is controlled in order to assign the information about the job, of which the reservation is accepted, to each job display area in one to one relation. Accordingly, the display according to the number N2 of the reservation acceptable jobs can be carried out on the display unit.

It is preferred that the conveyance path of the transfer paper from the start of the feed to the end of the exit in the image forming device comprises a conveyance path in the finisher.

According to the present invention, the number N2 of the reservation acceptable jobs can be set according to the conveyance path which is variable according to the model of the finisher and the presence or absence of the connection of the finisher.

### BRIEF DESCRIPTION OF THE DRAWINGS

The present invention will become more fully understood from the detailed description given hereinafter and the accompanying drawing given by way of illustration only. However thus are not intended as a definition of the limits of the present invention. Wherein:

FIG. 1 is a block diagram showing a functional configuration of an image forming device 100 related to the present invention;

FIG. 2A is a diagram showing a configuration of a reserve job cue, FIG. 2B is a diagram showing a configuration of a job cue, FIG. 2C is a diagram showing a configuration of a successive print cue;

FIG. 3A is a diagram showing an example of an operation screen 221 displayed on a LCD 22 in FIG. 1, FIG. 3B is a diagram showing an example of a reserve screen 222 displayed on the LCD 22 in FIG. 1;

FIG. 4 is a diagram showing an internal structure of the image forming device 100 in FIG. 1;

FIG. 5 is a flow chart showing a next job feeding operation judging processing, which is carried out by a control unit 11 in FIG. 1;

FIG. 6 is a diagram showing a status of an operation of a motor and a detection signal of a sensor, which are related to a feed and an exit, when a large amount of jobs are output in the condition that the maximum number of the conveyed transfer paper is 5, the number of the reservation acceptable jobs is 3 and each job is small job for providing a piece of paper;

FIG. 7 is a diagram showing a status of an operation of a motor and a detection signal of a sensor, which are related to a feed and an exit, when a large amount of jobs are output in the condition that the maximum number of the conveyed transfer paper is 5, the number of the reservation acceptable jobs is 5 and each job is small job for outputting a piece of paper; and

FIG. 8 is a flow chart showing the number of the reservation acceptable jobs setting processing, which is carried out by the control unit 11 in FIG. 1.

### PREFERRED EMBODIMENTS OF THE INVENTION

Hereinafter, the embodiment of the present invention will be explained referring to the drawings at pleasure.

First, a configuration will be explained.

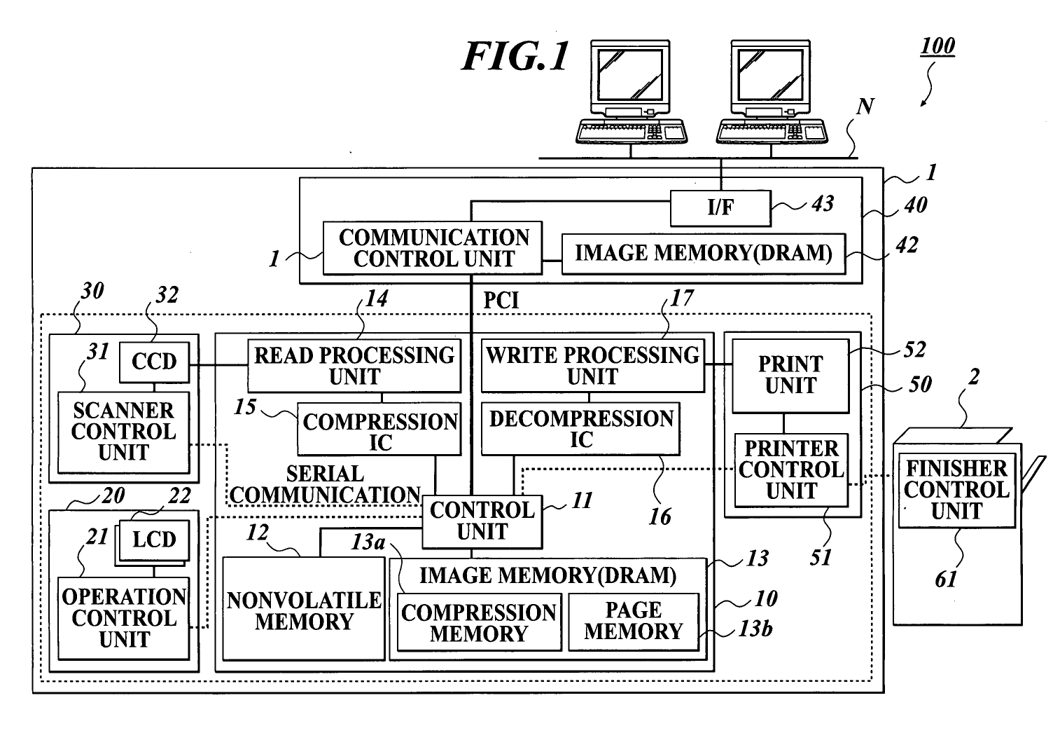

FIG. 1 is a block diagram showing a functional configuration of an image forming device 100 related to the present invention.

As shown in FIG. 1, the image forming device 100 comprises an image forming device main body 1 comprising an image control unit 10, an operation control unit 20, a scanner unit 30, a communication unit 40 and a printer unit 50, and a finisher 2 optionally connected to the image forming device main body 1.

The image control unit 10 comprises a control unit 11, a nonvolatile memory 12, an image memory 13, a read processing unit 14, a compression IC 15, a decompression IC 16 and a write processing unit 17.

The control unit 11 comprises a CPU (Central Process Unit), a ROM (Read Only Memory) and a RAM (Random Access Memory). The CPU loads a system program and various process programs memorized in the ROM, and develops such programs to the RAM. Then the CPU carries out central control of operations of each unit of the image forming device 100, according to the developed programs. In addition, the CPU carries out various process including a next job feeding operation judging processing and the number of the reservation acceptable jobs setting processing, which are mentioned after, according to the loaded programs.

In addition, the control unit 11 generates job data, based on an operation signal from the operation display unit 20 and instruction data input from the communication unit 40. Accordingly, the control unit 11 carries out job management by allocating the job data to a reserve job cue, a job cue and a successive print cue. The job data are the data comprising job ID for identifying the job, the number of print, various operation setting, memory location of the image data or the like.

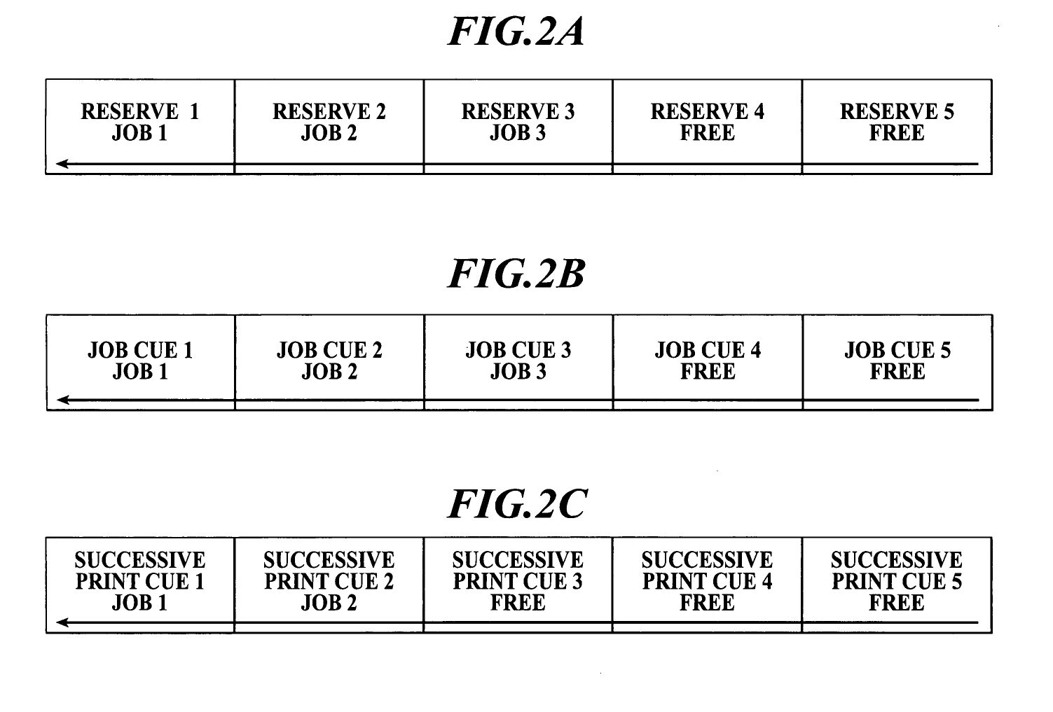

In FIG. 2A to 2C, examples of configuration of the reserve job cue, the job cue and the successive print cue are shown. The job data are allocated to free cues of the reserve job cues having a lower reservation number, in order of the generation thereof. The number of the reserve job cues corresponds to the number of the reservation acceptable jobs in the image forming device 100. FIG. 2A shows the reserve job cue, of which the number of the reservation acceptable jobs is 5, and where the job 1 to 3 are allocated to reserve 1 to 3.

When the job data are allocated to the reserve job cues and the printable status is set, the job data are allocated to the free cues of the job cues in ascending order of the job cue number, as shown in FIG. 2B. The job cue 1 shows the first job, which is proceeding toward the exit, as the print cue. The number of the successive print cues is controlled by the number of the reserve job cues.

The job data of the job that the feed is carried out, other than the job allocated to the job cue 1 (print cue), are allocated to free cues having a lower successive print cue number of the successive print cue, in order of the proceeding toward the exit, as shown in FIG. 2C. The number of the successive print cues is controlled by the above-mentioned number of the reserve job cue.

The job data allocated to the reserve job cue and the job cue, are maintained until the last page of that job is exited. After the last page is exited, the job data is removed from the cue. Accordingly the job data of each cue are moved forward sequentially. In addition, when the print out of the job of the successive print cue is started and allocated to the job cue 1 (the print cue), the job data is removed from the successive print cue. Accordingly the allocated job data are moved forward sequentially.

By the management of the above-mentioned reserve job cue, job cue and successive print cue, in the case that the reserve job is registered, the control unit 11 manages the jobs so as to carry out the jobs continuously without stopping a machine between each of jobs.

In addition, the control unit 11 is connected to a communication control unit 41 in the communication unit 40 with PCI bus. The control unit 11 controls inputs and outputs between the communication unit 40 and the image control unit 10.

The nonvolatile memory 12 memorizes various setting data or the like related to the image forming device 100.

The image memory 13 comprises a DRAM (Dynamic Random Access Memory), a compression memory 13a and a page memory 13b. The compression memory 13a memorizes compressed data such as image data or the like compressed by the compression IC 15, by the control by the control unit 11. The page memory 13b stores image data for one page decompressed by the decompression IC 16, by the control by the control unit 11.

The read processing unit 14 converts an analog image signal read by the scanner unit 30 to digital image data, and outputs it to the compression IC 15.

The compression IC 15 compresses the image data input from the read processing unit 14 and image data input from the communication unit 40 via the control unit 11. Then, the compression IC 15 outputs the compressed data to the compression memory 13a based on the control from the control unit 11.

The decompression IC 16 decompresses the compressed data input from the compression memory 13a by the control by the control unit 11. Then, the decompression IC 16 outputs the decompressed data to the write processing unit 17.

The write processing unit 17 generates a PWM (Pulse Width Modulation) signal based on the image data input from the decompression IC 16, and outputs it to the printer unit 50.

The operation display unit 20 comprises an operation unit and an display unit. In addition, the operation display unit 20 comprises an operation control unit 21, a LCD (Liquid Crystal Display) 22 or the like.

The operation control unit 21 receives a display signal from the control unit 11, and controls the display on the LCD 22. In addition, the operation control unit 21 outputs an operation signal, which is input from a touch panel on the LCD 22, to the control unit 11.

The LCD 22 displays various operation buttons, a status of an image, a status of an operation of each function or the like on the screen, according to an instruction of display signal input from the operation control unit 21. The display screen of the LCD 22 is covered with a transparent sheet panel. The display screen comprises the touch panel for outputting position information, which is input by touching with fingers or a proprietary stylus pen, to the operation control unit 21 as input information.

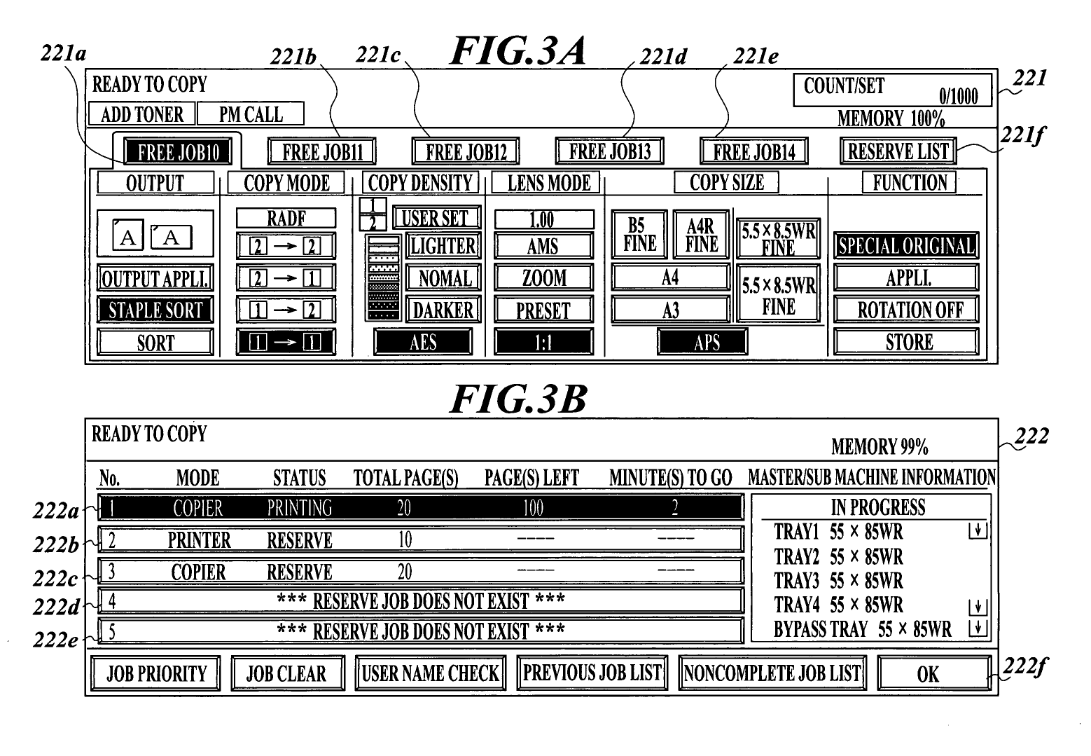

In FIG. 3A, an example of an operation screen 221 displayed on the LCD 22 is shown. As shown in FIG. 3A, on the operation screen 221, reserve tags 221a to 221e are displayed. The number of the reserve tags corresponds to the number of the reservation acceptable jobs in one to one relation. Here, it is shown that the five jobs are reservable. The reserved jobs are allocated to the free reserve tags sequentially from the left side of the screen in one to one relation. Each of the reserve tags is the simplified job display area, and shows the status of the allocated job. For example, “FREE” displayed on the reserve tag means that no jobs exist, “PRINTING” means that the job is at the print, “RESERVE” means that the job is waiting for the print, and “STOP” means that the print is stopped. When each of the reserve tags is pressed, the detail of the job allocated to the reserve tag is displayed on the screen. When a reserve list button 221f is pressed, a reserve screen 222 is displayed. On the reserve screen 222, as shown in FIG. 3B, the job display area 222a to 222e of which the number corresponds to the number of the reserve tags, are displayed. Further, the list of the statuses of the reserved jobs is displayed. When a OK button 222f is pressed, the operation screen 221 is displayed again.

The number of the reserve tags on the operation screen 221 and the number of the job status display areas on the reserve screen 222 are changed by the operation control unit 21 based on the control from the control unit 11.

The operation display unit 20 in FIG. 1 comprises, as for rest, various operation buttons such as a numerical button, a function button for switching various settings, operation modes or the like, a start button or the like, which are not shown in the figure. The operation display unit 20 outputs an operation signal by button operation from the operation control unit 21 to the control unit 11.

The scanner unit 30 is an image reading unit, and disposed under a contact glass on which original is placed. In addition, the scanner unit 30 comprises a scanner control unit 31, a CCD (Charged Coupled Device) 32 or the like.

The scanner control unit 31 receives a control signal from the control unit 11. Accordingly the scanner control unit 31 activates and controls the CCD 32. The CCD 32 carries out photoelectric conversion by imaging the reflection of the light lighted and scanned form a light source, which are not shown in the figure, to the original. Then, by doing so, the CCD 32 reads an image of the original and further outputs the read analog image signal to the read processing unit 14. Here, the image comprises text data or the like, such as letters, marks or the like, not limited to image data such as graphics, photographs or the like.

The communication unit 40 comprises the communication control unit 41, an image memory 42, an I/F 43 or the like.

The communication control unit 41 controls an operation of each portion of the communication unit 40. Then, the communication control unit 41 sends and receives data between the communication control unit 41 and an external equipment such as a terminal or the like connected to a network N. In addition, the communication control unit 41 is connected to the control unit 11 in the image control unit 10 with PCI bus. The communication control unit 41 controls inputs and outputs of data between the communication unit 40 and the image control unit 10.

The image memory 42 comprises the DRAM. The image memory 42 temporary stores data received from the external equipment through the network N and image data output from the image control unit 10 through the PCI bus.

The I/F 43 is an interface connectable to transmission media connected to the network N such as a LAN (Local Area Network), a WAN (Wide Area Network), the Internet or the like. The I/F 43 outputs image data, which is input through the network N, to the communication control unit 41. Further, the I/F 43 sends the image data, which is output from the communication control unit 41, to external equipments through the network N.

The printer unit 50 is an image forming unit, and comprises a printer control unit 51, a print unit 52 or the like.

The printer control unit 51 receives a control signal from the control unit 11. Then the printer control unit 51 prints out by controlling the operation of each portion of the printer 50. In addition, the printer control unit 51 relays data communication between the control unit 11 and a finishing control unit 61.

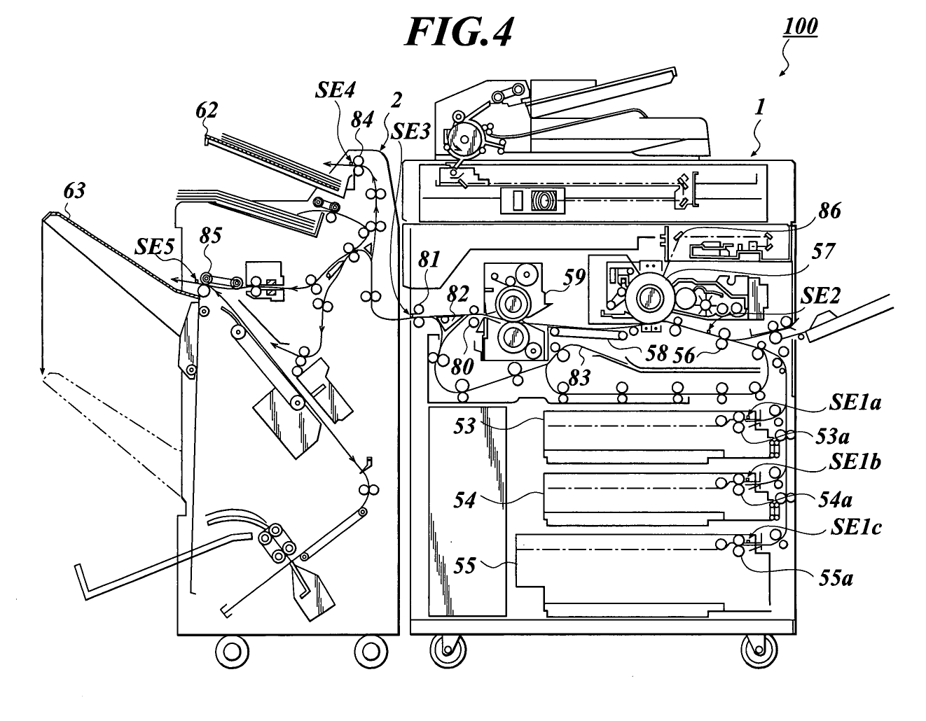

The print unit 52 comprises a LD (Laser Diode) 86, a photosensitive drum 57, feeding cassettes 53 to 55, a exit roller 81 or the like (shown in FIG. 4). The print unit 52 conveys the transfer paper, of which the size and the direction are instructed by the input from the operation display unit 20 according to the print instruction from the printer control unit 51, or instructed by instruction data included in data received through the communication unit 40, from any of the feeding cassettes 53 to 55, which corresponds to the size and the direction of the transfer paper. Then an electrostatic latent image is formed with irradiation of a laser onto the surface of the photosensitive drum 57, based on a PWM signal input from the write processing unit 17. Further, the print unit 52 adheres toner on the area of the surface of the photosensitive drum 57 comprising the electrostatic latent image. Then, the print unit 52 forms an image by transferring the toner onto the transfer paper conveyed from the feeding cassettes 53 to 55. Accordingly, the toner is fixed by a fixing unit 59. After that, the transfer paper is exited via the exit roller 81.

Each portion of the finisher 2 is controlled by the finishing control unit 61 based on the control signal input from the control unit 11 via the printer control unit 51. According to such control, the finisher 2 gathers a plurality of transfer paper, on which the image is formed by the printer unit 50. Further, the finisher 2 carries out the finishing such as stapling, saddle-stitching, folding or the like.

Next, an operation will be explained.

First, with reference to the internal structure diagram of the image forming device 100 in FIG. 4, a print out operation onto the transfer paper in the image forming device 100 will be explained.

The transfer paper are stored in the feeding cassettes 53, 54 and 55 shown in FIG. 4. The control unit 11 drives the paper feed rollers 53a, 54a or 55a selectively via a first feed motor which is not shown in the figure, based on the job data allocated to the reserve job cue. Accordingly, the transfer paper is fed piece by piece from any of feeding cassette 53 to 55 (the first feed). Then, the transfer paper is conveyed while it is synchronized with a toner image, which is formed on the surface of the photosensitive drum 57 by the timing roller 56 (the second feed). Accordingly the image is transferred to the transfer paper. After the transfer, the transfer paper is conveyed to the fixing unit 59 via the conveying belt 58. Then, the toner is fixed, and the transfer paper is exited to the finisher 2 via the conveying roller 80 and the exit roller 81. Alternatively, the transfer paper, which is processed an image processing on one side thereof is conveyed to the automatic duplex copying feed unit 83 by the conveyance path switching plate 82. Then the transfer paper is conveyed again via the timing roller 56, the conveying belt 58, the conveying roller 80 and the exit roller 81. Accordingly the transfer paper is exited to the finisher 2.

The first feed is detected by first feed sensors SE1a, SE1b and SE1c, which are respectively placed near the paper feed rollers 53a, 54a and 55a. Accordingly a detection signal is output to the control unit 11. In other words, the first feed is detected by the first sensor SE1a, when the feed is carried out from the feeding cassette 53. In addition, the first feed is detected by the first sensor SE1b, when the feed is carried out from the feeding cassette 54. And the first feed is detected by the first sensor SE1c, when the feed is carried out from the feeding cassette 55. Then, the detection signal is output to the control unit 11. The second feed is detected by a second feed sensor SE2 which is placed near the timing roller 56. Accordingly a detection signal is output to the control unit 11. The exit from the image forming device main body 1 is detected by an exit sensor SE3 which is placed near the exit roller 81. Accordingly a detection signal is output to the control unit 11.

The transfer paper exited form the image forming device main body 1 is conveyed on a conveyance path corresponding to a finishing to be carried out, in the finisher 2. The transfer paper is exited from the fixed exit tray 62 via the exit roller 84, or from the vertically movable exit tray 63 via the exit roller 85. The exit from the finisher 2 is detected by the finisher exit sensor SE4 which is placed near the exit roller 84, or by the finisher exit sensor SE5 placed near the exit sensor 85. Accordingly a detection signal is output to the control unit 11.

As mentioned above, the transfer paper is controlled by the control unit 11 based on the reserve job cue. By such control, the transfer paper is fed from the feeding cassettes. Then, the transfer paper is conveyed on the conveyance path in the image forming device 100 and the conveyance path in the finisher 2. Accordingly, after the print is carried out, the transfer paper is exited. However, the number of the transfer paper, which can be provided on the conveyance path of the transfer paper from start of the feed until the end of the exit, has limitation. The maximum number of the conveyed transfer paper is determined according to the model of the image forming device main body 1 and the finisher 2. Therefore, the maximum number of the conveyed transfer paper of the image forming unit 100 has difference depending on the model of the optional finisher 2, or the presence or absence of the connection of the finisher 2. The control unit 11 carries out a next job feeding operation judging processing and the number of the reservation acceptable jobs setting processing, which are mentioned after. Then the control unit 11 controls the feed and the conveyance of the transfer paper so that the successive job is carried out according to a status of the reserve job and the maximum number of the conveyed transfer paper,

Incidentally, in the present invention, the maximum number of the conveyed transfer paper existing on the conveyance path at the same time denotes the number of the transfer paper capable of existing at the same time in the case that A4 sized paper is fed and conveyed in landscape orientation in the conveyance direction. In addition, the conveyance path for conveying the transfer paper from the feed until the exit denotes the conveyance path in the recording device excepting the feeding cassette and the exit tray. Then, in the case that an additional paths such as a duplex copying, a reversing device or the like are provided, these paths are also defined as the conveyance path.

In addition, the successive execution of the job is to control for carrying out the image forming on the transfer paper continuously without stopping the image forming process in the case that when the last transfer paper of the current job is fed, the reservation of the next job is registered.

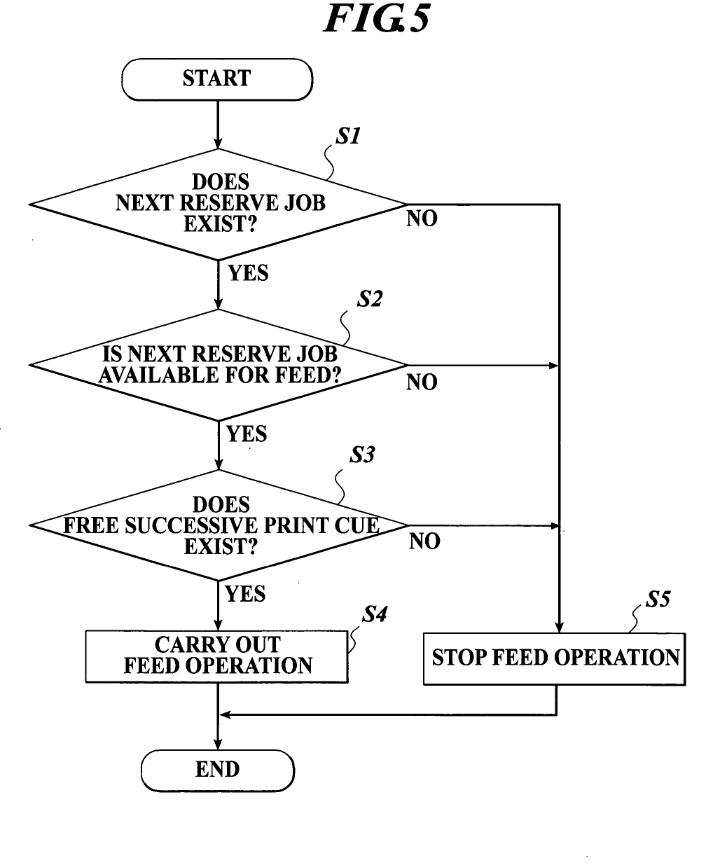

In FIG. 5, the next job feeding operation judging processing is shown, which is carried out in the control unit 11. In the case that the successive job of the small job is carried out, the control unit 11 has a feed timing of the next reserve job (the next job) at a predetermined time interval after the feed of the previous reserve job is completed, based on the maximum number of the conveyed transfer paper. The present processing is carried out at the feed timing of the next job. Hereinafter, with reference to FIG. 5, the next job feeding operation judging processing will be explained.

First, it is judged whether or not a next reserve job exists in the reserve job cue. Then, in the case that no next reserve job exists (step S1; NO), the processing proceeds to a step S5. Accordingly, the feed is stopped, and the present processing is terminated. When the next job exists (step S1; YES), it is judged whether or not the next job is available for the feed. Then, in the case that the feed cannot be carried out (step S2; NO), the processing proceeds to a step S5. Accordingly, the feed is stopped, and the present processing is terminated. The judgment whether or not the next job is the job available for the feed is carried out as follows, for example: based on the job data, the setting of the operation of the next reserve job is compared with that of the previous job; then, it is judged whether or not a transfer paper size and a feeding mode of both jobs are the same each other; when they are the same each other, it is further judged whether or not an operation mode set in the next reserve job is a mode capable of carrying out a real output operation (an operation for outputting an image data of an input original, sequentially in real time); then, when the operation mode is capable of carrying out the real output operation, the control unit 11 judges that the next reserve job is the job available for the feed. When the next reserve job is available for the feed (step S2; YES), the control unit 11 judges whether or not a free successive print cue exists. Then, when the free successive print cue does not exist, the processing shifts to the step S5. Accordingly, the feeding is stopped, and the present processing is completed. When the free successive print cue exists (step S3; NO), the feed operation is carried out. Then, the transfer paper is fed from a feeding cassette storing the transfer paper having the size and the direction based on the job data (step S4).

Here, in the next job feeding operation judging processing mentioned above, when it is judged that the next reserve job is not registered, the feed is not carried out at the time when the feed should be carried out in the next job. Therefore, the productivity in the present case is decreased compared with that in the case of the successive feed. In other words, when it is judged that the next reserve job is not registered in the step S1, the successive job is lost by the feed operation being stopped. Accordingly, when all the transfer paper at the print are exited, a main motor for driving each part of the printer unit 50, which is not shown in the figure, is stopped. Accordingly, the machine gets into a stopped state. Even if the next job is reserved after such state, it is necessary that the main motor is activated again to operate each part. therefore, the productivity in the present case is extremely decreased compared with that in the case of the successive feed.

Hence, in the case that the next reserve job is registered at the feed timing of the next job, the successive job can be carried out. Consequently, the productivity can be improved. For such improvement, the number of the reservation acceptable jobs must be a suitable value with respect to the maximum number of the conveyed transfer paper.

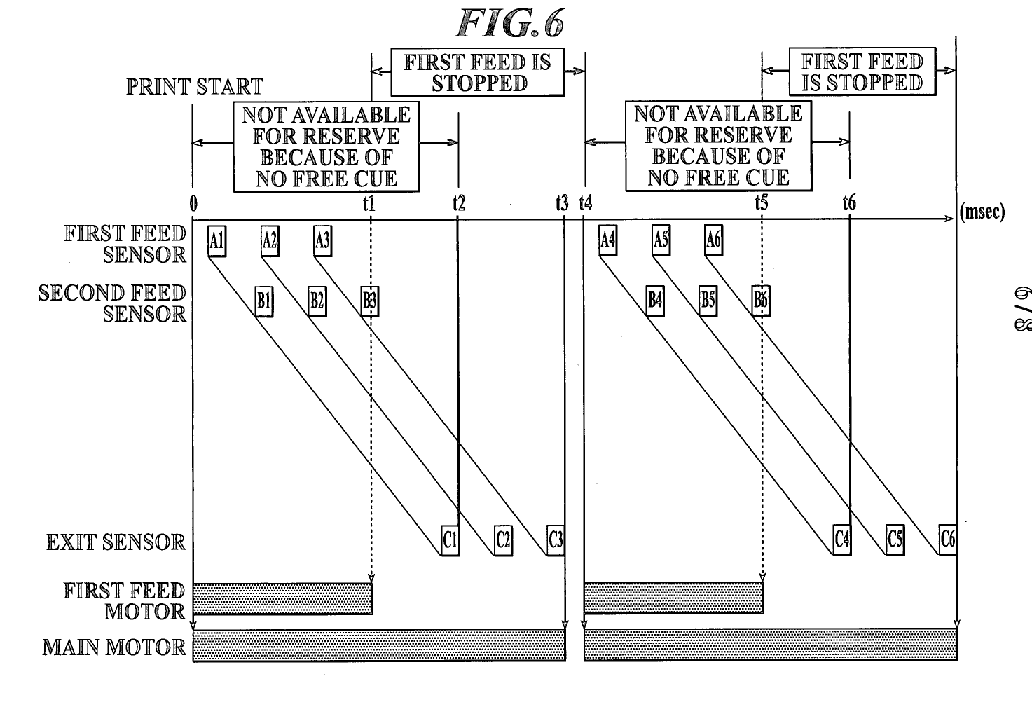

As an example of operations of the feed and the exit in the case that the number of reservation acceptable jobs<the maximum number of the conveyed transfer paper, FIG. 6 shows a status of an operation of a motor and a detection signal of sensor, which are related to the feed or the exit, when a large amount of jobs are output in the condition that the maximum number of the conveyed transfer paper is 5, the number of reservation acceptable jobs is 3 and each job is small job for providing a piece of paper.

In the case that all of the three reserve job cues are already reserved, when the print is started, the feed of the first job is carried out from any of the feeding cassettes 53 to 55. Then a detection signal A1 from any of the first feed sensors SE1a to SE1c is output. Next, the above next job feeding operation judging processing is carried out at the feed timing of the next reserve job. Then the feed of the second job is carried out. Accordingly, a detection signal A2 from any of the first feed sensors SE1a to SE1c is output. Next, the above next job feeding operation judging processing is carried out at the feed timing of the next reserve job. Then the feed of the third job is carried out. Accordingly, a detection signal A3 from any of the first sensors SE1a to SE1c is output. Next, the above next job feeding operation judging processing is carried out. However, the next job cannot be reserved because a free reserve job cue does not exist for the limitation of the number of the reservation acceptable jobs. Therefore, at the time of t1, the feed operation is stopped by stopping the first feed motor.

The transfer paper of the first job detected by the detection signal A1 of the first feed sensor is conveyed on the conveyance path. Then a detection signal B1 is output when the transfer paper passes the second feed sensor SE2. Similarly, the transfer paper of the second job detected by the detection signal A2 is conveyed on the conveyance path. Then a detection signal B2 is output when the transfer paper passes the second feed sensor SE2. The transfer paper of the third job detected by the detection signal A3 is conveyed on the conveyance path. Then a detection signal B3 is output when the transfer paper passes the second feed sensor SE2.

The transfer paper of the first job, which is detected by the detection signal A1 of the first feed sensor, is further conveyed on the conveyance path. Then, when the transfer paper passes the exit sensor SE3 (SE4, SE5, in the case that the finishing processing is carried out), the detection signal C1 is output. In the same way, the transfer paper of the second job, which is detected by the detection signal A2, is conveyed on the conveyance path. Then, when the transfer paper passes the exit sensor SE3 (SE4, SE5, in the case that the finishing processing is carried out), the detection signal C2 is output. The transfer paper of the third job, which is detected by the detection signal A3, is conveyed on the conveyance path. Then, when the transfer paper passes the exit sensor SE3 (SE4, SE5, in the case that the finishing processing is carried out), the detection signal C3 is output.

Here, the new reserve job cannot be registered, because free reserve job cue does not exist for the reason of the limitation of the number of the reservation acceptable jobs, until the transfer paper of the first job is exited, in other words, from the start of the print until the point of t2 at which the detection by the detection signal C1 is finished. Then, after the elapse of t2, the fourth job can be reserved. In this period, at the point of t1, the first feed is stopped because the next reserve job does not exist. In addition, the main motor is stopped at the point of t3 at which the detection by the detection signal C3 is finished. After that, in the case that some reservations exist after t2, each motor is activated at the point of t4. Then, the print is started. Accordingly, the similar operation to the above operation from the feed to the exit in the first job to the third job. Therefore, the successive job is once stopped at the feed timing after the detection signal A3 is detected. In addition, the feed operation is interrupted until the next successive job is started. In other words, the printout operation is interrupted.

In FIG. 6, the case that the number of the reservation acceptable jobs is 3 is explained. However, in the case that the number of the reservation acceptable jobs<the maximum number of the conveyed transfer paper, in the same way, after the reservations corresponding to the number of the reservation acceptable jobs are registered, the next job cannot be reserved until the exit of the first job is completed. Then, the feed operation is interrupted. In addition, the printout operation is interrupted.

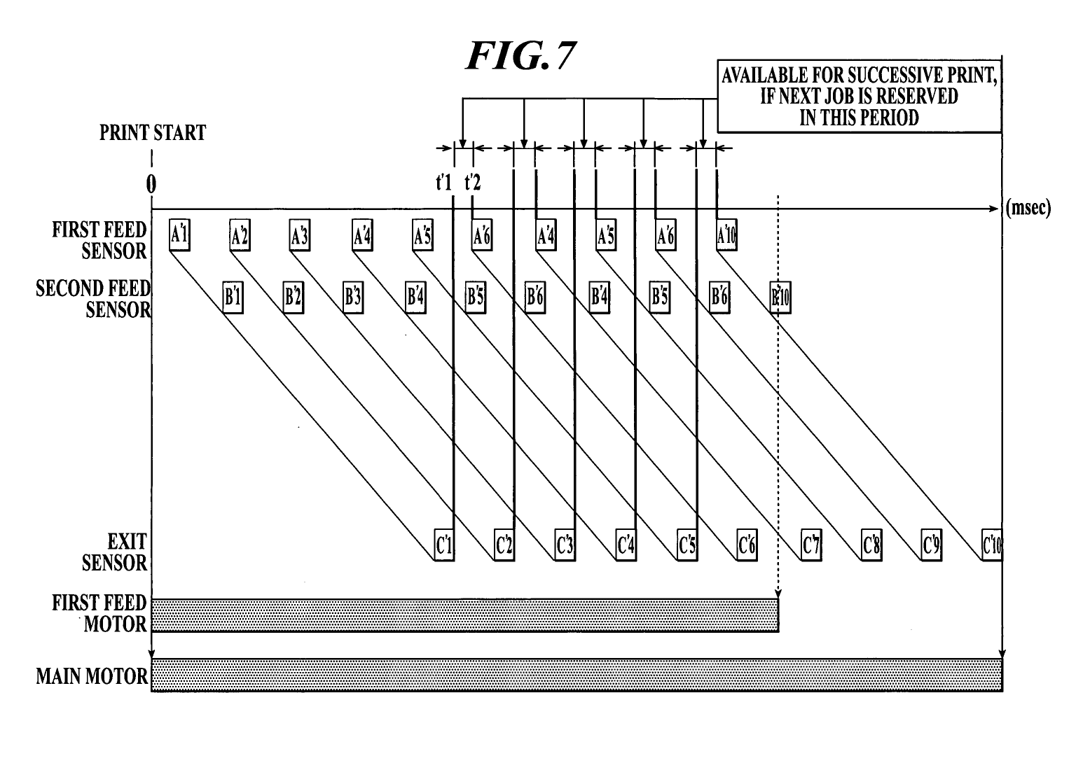

As an example of operations of the feed and the exit in the case that the number of the reservation acceptable jobs=the maximum number of the conveyed transfer paper, FIG. 7 shows a status of an operation of a motor and a detection signal of sensor, which are related to the feed or the exit, when a large amount of jobs are output in the condition that the maximum number of the conveyed transfer paper is 5, the number of the reservation acceptable jobs is 5 and each job is small job for providing a piece of paper.

In the case that all of the five reserve jobs are already registered, when the print is started, the feed of the first job is carried out from any of the feeding cassettes 53 to 55. Then a detection signal A′1 from any of the first feed sensors SE1a to SE1c. Next, the above next job feeding operation judging processing is carried out at the feed timing of the next reserve job. Then the feed of the second job is carried out. Accordingly, a detection signal A′2 from any of the first feed sensors SE1a to SE1c is output. In the same way, the feed of the third job, the fourth job and the fifth job, are carried out. In addition, detection signals A′3, A′4 and A′5 are output.

The transfer paper of the first job detected by the detection signal A′1 of the first feed sensor is conveyed on the conveyance path. Then a detection signal B′1 is output when the transfer paper passes the second feed sensor SE2. Similarly, the transfer paper of the second job detected by the detection signal A′2 is conveyed on the conveyance path. Then a detection signal B′2 is output when the transfer paper passes the second feed sensor SE2. Similarly, the transfer paper of the third job, the transfer paper of the fourth job and the transfer paper of the fifth job are conveyed on the conveyance path. Then detection signals B′3, B′4, B′5 are output.

The transfer paper of the first job, which is detected by the detection signal A′1 of the first feed sensor, is further conveyed on the conveyance path. Then, when the transfer paper passes the exit sensor SE3, the detection signal C′1 is output. The transfer paper of the second job, which is detected by the detection signal A′2, is conveyed on the conveyance path. Then, when the transfer paper passes the exit sensor SE3, the detection signal C′2 is output. In the same way, the transfer paper of the third job, the transfer paper of the fourth job and the transfer paper of the fifth job are conveyed on the conveyance path. Then, when the transfer paper passes the exit sensor SE3, the detection signals C′3, C′4 and C′5 are output.

Here, the free reserve job cue exists at the time of t′1 after the output of the detection signal C′1. Accordingly, the next sixth job can be reserved. On the other hand, the feed of the sixth job cannot be carried out unless the transfer paper of the first job is exited, for the reason of the maximum number of the conveyed transfer paper. Therefore, the feed timing of the sixth job is the time after the detection signal C′1 is output. In other words, if the reserve job of the sixth job is reserved between t′1 at which the output of the detection signal C′1 is completed and the feed timing of the sixth job t′2, the successive jobs can be carried on. Then, the feed can be carried out successively. The seventh or later job can be also carried out successively. Then, the productivity can be improved compared with the case of FIG. 6.

Incidentally, in FIG. 7, the example of the case that the number of the reservation acceptable jobs=the maximum number of the conveyed transfer paper is shown. However, in the case that the number of the reservation acceptable jobs≧the maximum number of the conveyed transfer paper, the successive jobs can be carried on, by registering the reservation before the exit of the first job is completed. Accordingly, the feed can be carried out successively.

As mentioned above, if the number of the reservation acceptable jobs≧the maximum number of the conveyed transfer paper, the successive job can carried on, without stopping the first feed motor or the main motor. However, the number of the reservation acceptable jobs corresponds to the number of the reserve tags of the operation screen 221 of the operation display 20, and to the job status display area of the reserve screen 222, in one to one relation. Therefore, when the number of the reservation acceptable jobs is simply increased, burdens are placed to the control of the operation control unit 21. Consequently, it is required that the optimal number of the reservation acceptable jobs, which places small burdens to the control operation unit 21, is prepared, according to the maximum number of the conveyed transfer paper, which is variable according to the model of the optional finisher 2 or the presence or absence of the connection finisher 2.

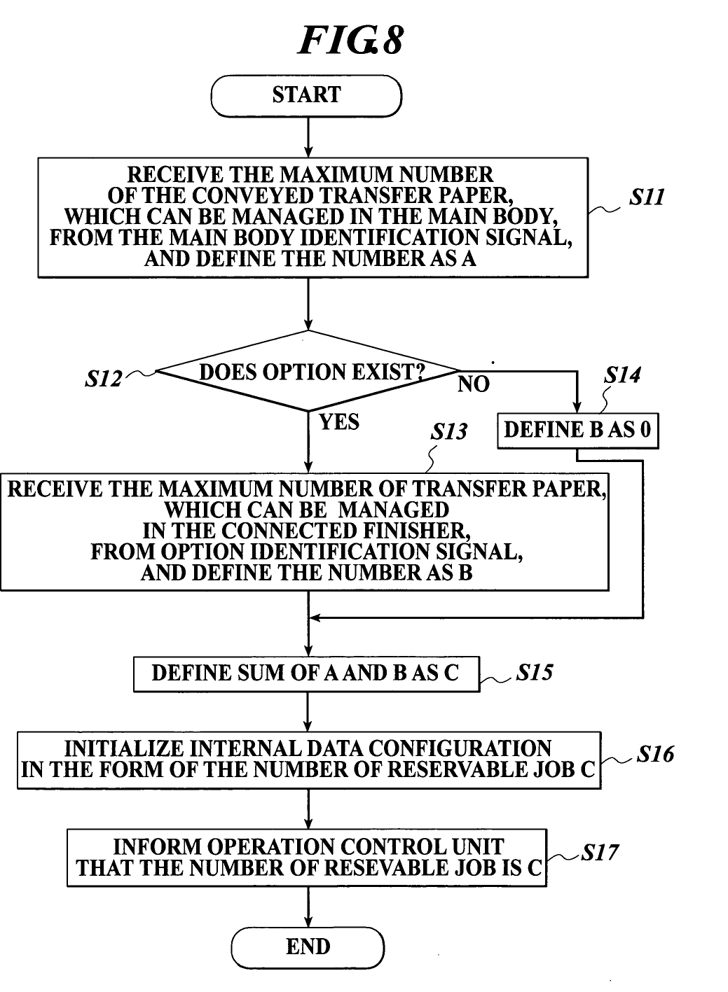

In FIG. 8, the number of the reservation acceptable jobs setting processing, which is carried out by the control unit 11, is shown. The present processing is carried out as an initial processing when the power is turned on.

First, the communication between the control unit 11 and the printer control unit 51 is carried out. Then, a main body identification signal is received from the printer control unit 51. Based on the received main body identification signal, information of the maximum number of the conveyed transfer paper which can be fully managed by the image forming device main body 1 is received. Then the information is stored in an area A in the RAM (step S11). The main body identification signal is the signal for identifying the model or the like of the printer unit 50. Then, according to that model, the information of the maximum number of the conveyed transfer paper is received, based on a table or the like which is memorized beforehand in the ROM.

Next, it is judged whether or not an option exists, in other words, the finisher 2 is connected to the image forming device main body 1 or not, by the communication between the control unit 11 and the printer control unit 51. Then, in the case that the option exists (step S12; YES), an option identification signal is received. Accordingly, based on the received option identification signal, the information of the maximum number of the conveyed transfer paper which can be fully managed in the finisher 2. Then, the information is stored in an area B in the RAM (step S13). The option identification signal is the signal for identifying the model or the like of the finisher 2. Then, according to that model, the information of the maximum number of the conveyed transfer paper is received, based on a table or the like which is memorized beforehand in the ROM. On the other hand, in the case that the option does not exist (step S12; NO), 0 is stored in the area B (step S14).

Next, by adding the value in the area A and the value in the area B, the result C is provided (step S5). The provided value C is set as the number of the reservation acceptable jobs. Accordingly, the internal data configuration such as the reserve job cue, the job cue, the successive print job cue or the like are initialized in the form of the number of the reservation acceptable jobs C (step S16). In addition, it is informed to the operation control unit 21 that the number of the reservation acceptable jobs is C (step S17). Then, the present processing is completed. In the control display unit 20, from then on, the reserve tags and job display areas corresponding to the number of the reservation acceptable jobs are displayed when the operation screen 221 or the reserve screen 222 is displayed.

Incidentally, in the number of the reservation acceptable jobs setting processing, which is shown in FIG. 8, the number of the reservation acceptable jobs are controlled so that the number of the reservation acceptable jobs corresponds to the maximum number of the conveyed transfer paper. However, the number of the reservation acceptable jobs may be set as the number of the reservation acceptable jobs≧the maximum number of the conveyed transfer paper, unless burdens are not placed to the operation control unit 21 (for example, the number of the reservation acceptable jobs=the maximum number of the conveyed transfer paper+1 or the maximum number of the conveyed transfer paper+2, more or less)

In addition, the number of the reservation acceptable jobs, which is greater than the maximum conveyable number provided by a combination of all options, may be fixed.

As explained above, according to the image forming device 100, the control unit 11 gets the maximum number of the conveyed transfer paper which can exist on the conveyance path of the transfer paper from the start of the feed to the end of the exit, based on the model of the printer 50, the presence or absence of the connection of the optional finisher 2, and the model of the optional finisher 2. Then, the control unit 11 sets the number of the reservation acceptable jobs so that the number of the reservation acceptable jobs is optimal according to the maximum number of the conveyed transfer paper. In other words, the number of the reservation acceptable jobs is set as the number of the reservation acceptable jobs≧the maximum number of the conveyed transfer paper. Accordingly, based on the number of the reservation acceptable jobs, the control unit 11 carrying out the management of the jobs, while the control unit 11 controls each unit such as the control display unit 20.

Accordingly, the successive jobs can be carried on without stopping the first feed motor or the main motor. Therefore, the plurality of reserved jobs can be carried out efficiently. In addition, the change of the conveyance path of the transfer paper according to the presence or absence of the connection of the finisher, can be also accepted flexibly.

Incidentally, the description in above embodiments is one of the examples of the image forming device 100 related to the present invention. Then, the present invention is not limited to the above embodiments.

In addition, the detail configuration or the detail operation of the image forming device 100 may be also changed accordingly without departing from the essence of the present invention.

The entire disclosure of Japanese Patent Application No. Tokugan 2003-188226 filed on Jun. 30, 2003 including specification, claims, drawings and summary are incorporated herein by reference in its entirety.

What is claimed is:

1. An image forming device comprising:
a control unit for accepting reservations of a plurality of jobs including an image forming processing, and for carrying out a job successive execution which starts a next job during an image forming of a last page of a current job, based on the plurality of jobs of which the reservations are accepted; and
a conveyance path for conveying a transfer paper, from a start of a feed of the transfer paper to an end of an exit of the transfer paper;
an image forming unit for forming and outputting an image on the transfer paper, based on an instruction from the control unit,
wherein in a case that the maximum number of the conveyed transfer paper existing at the same time on the conveyance path of the transfer paper from the start of the feed to the end of the exit in the image forming device is defined as N1, and the number of reservation acceptable jobs is defined as N2, the control unit sets the number N2 as N2≧1, and manages acceptance of the jobs according to the set number N2 of the reservation acceptable jobs.

2. The image forming device of claim 1, further comprising:
an image reading unit,
wherein the image forming unit forms the image based on an image data read by the image reading unit.

3. The image forming device of claim 1, wherein the control unit is capable of accepting a reservation of a new job by exiting the last page of the job.

4. The image forming device of claim 1, wherein the control unit receives the maximum number N1 of the conveyed transfer paper existing at the same time on the conveyance path of the transfer paper from the start of the feed to the end of the exit in the image forming device, based on a main body identification signal.

5. The image forming device of claim 4, wherein the control unit sets the number N2 of the reservation acceptable jobs, based on the N1 received based on the main body identification signal.

6. The image forming device of claim 1, further comprising:
a display unit for displaying various information,
wherein the control unit carries out a display on the display unit according to the set number N2 of the reservation acceptable jobs.

7. The image forming device of claim 6, wherein the display unit displays a tag or a job display area, which correspond to the decided number N2 of the reservation acceptable jobs.

8. The image forming device of claim 1, further comprising:
a display unit for displaying various information,
wherein the control unit controls the display unit to display the job display area, the number of the job display areas corresponding to the number N2 of the reservation acceptable jobs, and the control unit controls the display unit to assign information about the job, of which the reservation is accepted, to each job display area in one to one relation.

9. The image forming device of claim 1, wherein the image forming device is connectable with a finisher, and
wherein the control device sets the number N2 of the reservation acceptable jobs as N2≧N1, with respect to the maximum number N1 of the conveyed transfer paper exiting at the same time according to the conveyance path which is variable according to a model of the finisher and presence or absence of connection of the finisher.

10. An image forming method comprising:
accepting reservations of a plurality of jobs including an image forming processing;
carrying out a job successive execution which starts a next job during an image forming of a last page of a current job, based on the plurality of jobs of which the reservations are accepted; and
forming and outputting an image on a transfer paper, by using a conveyance path for conveying the transfer paper, from a start of the feed of the transfer paper to an end of an exit of the transfer paper;
wherein in a case that the maximum number of the conveyed transfer paper existing at the same time on the conveyance path of the transfer paper from the start of the feed to the end of the exit in an image forming device is defined as N1, and the number of the reservation acceptable jobs is defined as N2, in the accepting, a reservation which satisfies a condition of N2≧1 is acceptable.

11. The image forming method of claim 10, further comprising:
receiving an image data by reading the image,
wherein the forming and the outputting is carried out based on the received image data.

12. The image forming method of claim 10, wherein the accepting is capable of accepting a reservation of a new job by exiting the last page of the job.

13. The image forming method of claim 10, wherein in the accepting, the maximum number N1 of the conveyed transfer paper existing at the same time on the conveyance path of the transfer paper from the start of the feed to the end of the exit is received, based on a main body identification signal.

14. The image forming method of claim 13, wherein in the accepting, the number N2 of the reservation acceptable jobs is decided, based on the N1 received based on the main body identification signal.

15. The image forming method of claim 10, further comprising:
displaying various information on a display unit,
wherein the displaying is carried out by displaying on the display unit according to the number N2 of the reservation acceptable jobs.

16. The image forming method of claim 15, wherein the displaying is carried out by displaying a tag or a job display area, which correspond to the number N2 of the reservation acceptable jobs.

17. The image forming method of claim 10, further comprising:
the displaying various information on the display unit,
wherein the displaying is carried out by displaying the display area, the number of the display areas corresponding to the number N2 of the reservation acceptable job; and the displaying is carried out by assigning information about the job, of which the reservation is accepted, to each job display area in one to one relation.

18. The image forming method of claim 10, wherein the conveyance path of the transfer paper from the start of the feed to the end of the exit in the image forming device comprises a conveyance path in the finisher.
